(19) United States
(12) Patent Application Publication
(10) Pub. No.: US 2019/0072226 A1
(43) Pub. Date: Mar. 7, 2019

(54) CONFORMING PIPE INSULATION

(71) Applicant: Owens Corning Intellectual Capital, LLC, Toledo, OH (US)

(72) Inventor: Matthew Daniel Gawryla, Newark, OH (US)

(21) Appl. No.: 16/109,329

(22) Filed: Aug. 22, 2018

Related U.S. Application Data
(60) Provisional application No. 62/554,064, filed on Sep. 5, 2017.

(51) Int. Cl. F16L 59/02; B32B 3/16; B32B 7/02; B32B 19/04

(52) U.S. Cl. CPC F16L 59/021; B32B 3/16; B32B 2307/304; B32B 19/04; B32B 2307/536; B32B 7/02

(57) ABSTRACT

Pipe insulation formed as a flat board is disclosed. The pipe insulation has an inner region that is more compressible than an outer region.

### CROSS REFERENCE TO RELATED APPLICATIONS

This application claims priority to and any benefit of U.S. Provisional Patent Application No. 62/554,064, filed Sep. 5, 2017, the content of which is incorporated herein by reference in its entirety.

### FIELD

The general inventive concepts relate to pipe insulation and, more particularly, to pipe insulation that more readily conforms to an external shape of a pipe to be insulated.

### BACKGROUND

As shown in FIG. 1A, one type of conventional pipe insulation 100 is formed as a flat board 102 of an insulating material 104. Lengthwise v-grooves 106 are cut into the board 102 to form separate segments 108 of the insulating material 104. In FIG. 1A, eight of the segments 108 are shown, i.e., A1, A2, A3, A4, A5, A6, A7, and A8.

Optionally, a facing material 110 and/or a backing material 112 may be affixed to the insulating material 104, typically before the v-grooves 106 are cut into the insulating material 104. During installation, the facing material 110 will be situated between the insulating material 104 and a pipe 140 to be insulated. During installation, the backing material 112 will be situated outside of the insulating material 104 furthest from the pipe 140. These materials 110, 112 can serve any of a number of purposes, such as acting as a vapor barrier or adding support to the segments 108 of the insulating material 104.

Each segment 108 has a trapezoidal shape. Typically, each segment 108 will have the shape of an isosceles trapezoid, with an upper base 120 and a lower base 122. The upper base 120 and the lower base 122 are connected by a pair of legs 124. The upper base 120 and the lower base 122 are parallel to one another, while the legs 124 are not parallel to one another. A thickness 126 of the insulating material 104 is defined by the distance between the upper base 120 and the lower base 122.

The pipe insulation 100 formed as a grooved board (e.g., the grooved board 102, as shown in FIG. 1D) is desirable because it may be easier and/or cheaper to manufacture, transport, and/or store, as compared to pipe insulation formed as elongated cylinders. Furthermore, the pipe insulation 100 formed as the grooved board is often more versatile than cylindrically formed pipe insulation, since such cylinders are made to insulate only a specific size of pipe.

The v-grooves 106 described above allow the board 102 to be manipulated such that the legs 124 of adjacent segments 108 abut one another, thereby closing the v-groove 106 situated between the adjacent segments 108. In this manner, the flat board 102 is transformed into an elongated, hollow polygon of the insulating material 104, the polygon having n sides with n being the number of the segments 108 forming the polygon.

During installation, the board 102 is typically wrapped around the pipe 140 to be insulated until the insulating material 104 completely surrounds the pipe 140. Thereafter, the portion of the board 102 surrounding the pipe 140 can be separated from the rest of the board 102 and sealed to hold its shape. In this manner, a polygon insulating member is formed which has the minimum number of sides required to surround the pipe 140.

For example, as shown in FIG. 1B, the pipe insulation 100 is represented by the board 102 being transformed into a hexagonal insulating member 130. The insulating member 130 is an elongated, hollow polygon formed from six of the segments 108 of the insulating material 104 (i.e., A1, A2, A3, A4, A5, and A6). The insulating member 130 includes an inner cavity 132 for receiving the pipe 140 to be insulated by the insulating member 130.

Because the insulating material 104 is substantially rigid (i.e., resists deformation), the cavity 132 of insulating member 130 must necessarily be larger than needed to completely surround the pipe 140. This can be seen in FIG. 1C, where an outer surface of the pipe 140 is closest to the mid-points 150 of the segments 108 of the insulating material 104, and where the outer surface of the pipe 140 is furthest from the corners 152 formed where adjacent segments 108 of the insulating material 104 abut one another. Consequently, significant gaps 160 are created between the outer surface of the pipe 140 and the inner surface of the insulating member 130. In FIG. 1C, six such gaps 160 are present, i.e., at the corresponding corners 152.

These gaps 160 are detrimental to the pipe insulation 100 because the gaps 160 lessen the insulative capacity of the insulating member 130 relative to the pipe 140, as well as serving as a pathway for moisture to condense and travel within the pipe insulation 100. This issue can be exacerbated if there are projections or other related structure (e.g., flanges, valves) extending from the outer surface of the pipe 140.

Consequently, there is an unmet need for pipe insulation formed as a flat, grooved board that more readily conforms to an outer surface of a pipe (e.g., the pipe 140) during installation of the pipe insulation on the pipe.

### SUMMARY

It is proposed herein to provide pipe insulation that more readily conforms to an external shape of a pipe (and any attendant fittings) to be insulated.

Accordingly, the general inventive concepts relate to and contemplate pipe insulation that is formed as a flat board-like member, as well as methods of and systems for producing the pipe insulation. The pipe insulation has a first region that is more compressible than a second region.

Numerous other aspects, advantages, and/or features of the general inventive concepts will become more readily apparent from the following detailed description of exemplary embodiments, from the claims, and from the accompanying drawings being submitted herewith.

### BRIEF DESCRIPTION OF THE DRAWINGS

The general inventive concepts, as well as embodiments and advantages thereof, are described below in greater detail, by way of example, with reference to the drawings in which:

FIGS. 1A-1D illustrate conventional pipe insulation in the form of a flat, grooved board. FIG. 1A is a front elevational view of the board. FIG. 1B is a diagram of an insulating member formed from a portion of the board of FIG. 1A. FIG. 1C shows the insulating member of FIG. 1B situated around a pipe. FIG. 1D is an upper perspective view of a portion of the board of FIG. 1A.

FIGS. 2A-2D illustrate pipe insulation in the form of a flat, grooved board, according to an exemplary embodiment of the invention. FIG. 2A is a front elevational view of the board. FIG. 2B is a detailed view of the circled region of FIG. 2A. FIG. 2C is a diagram of an insulating member formed from a portion of the board of FIG. 2A. FIG. 2D shows the insulating member of FIG. 2C situated around a pipe.

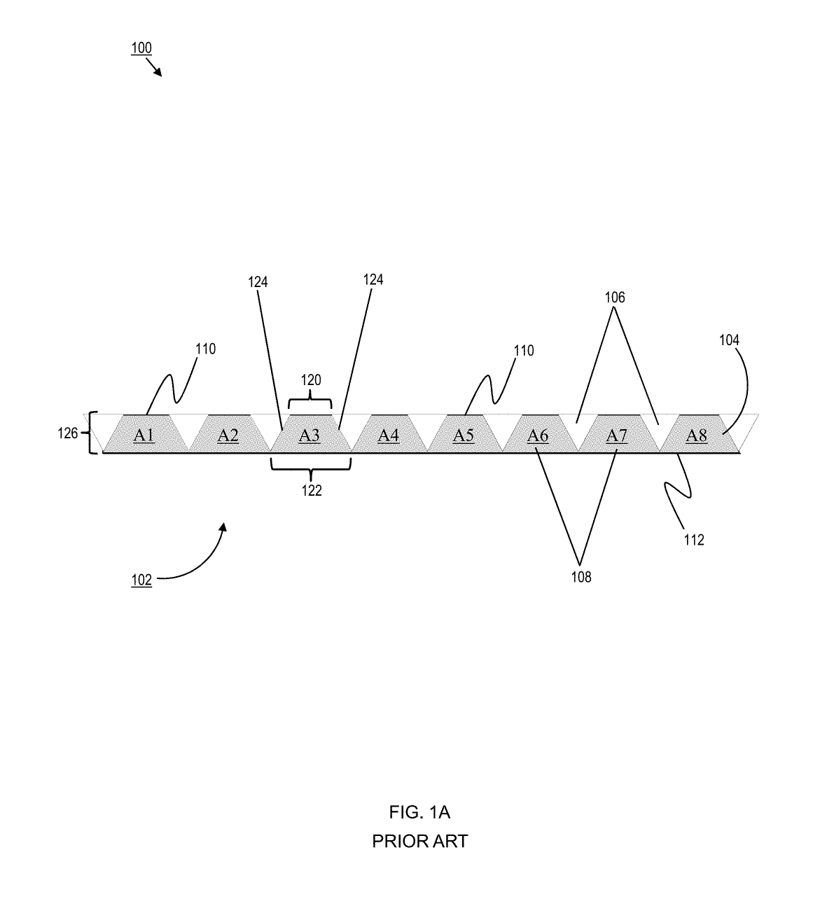

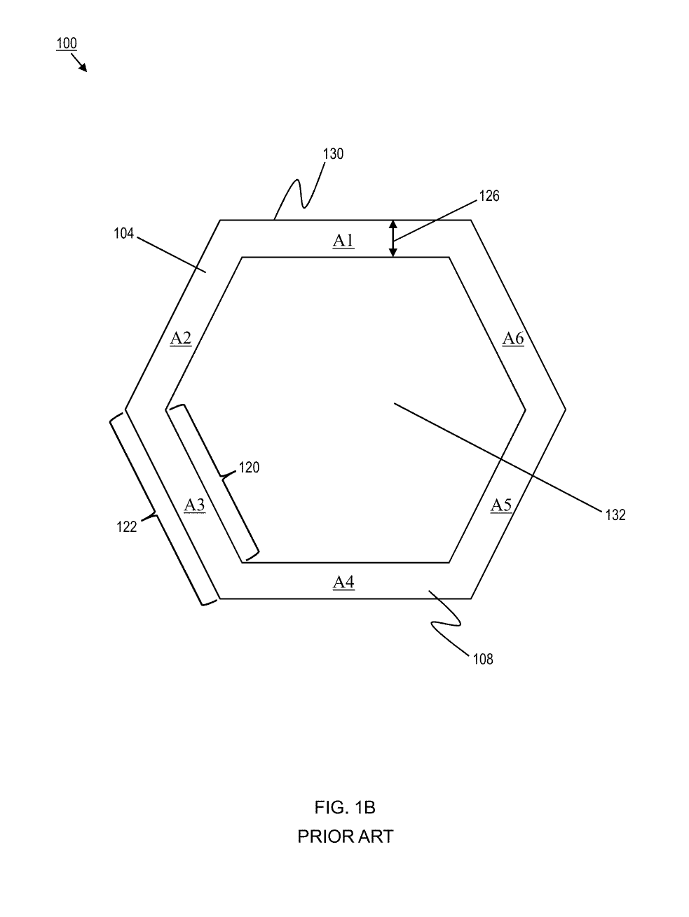

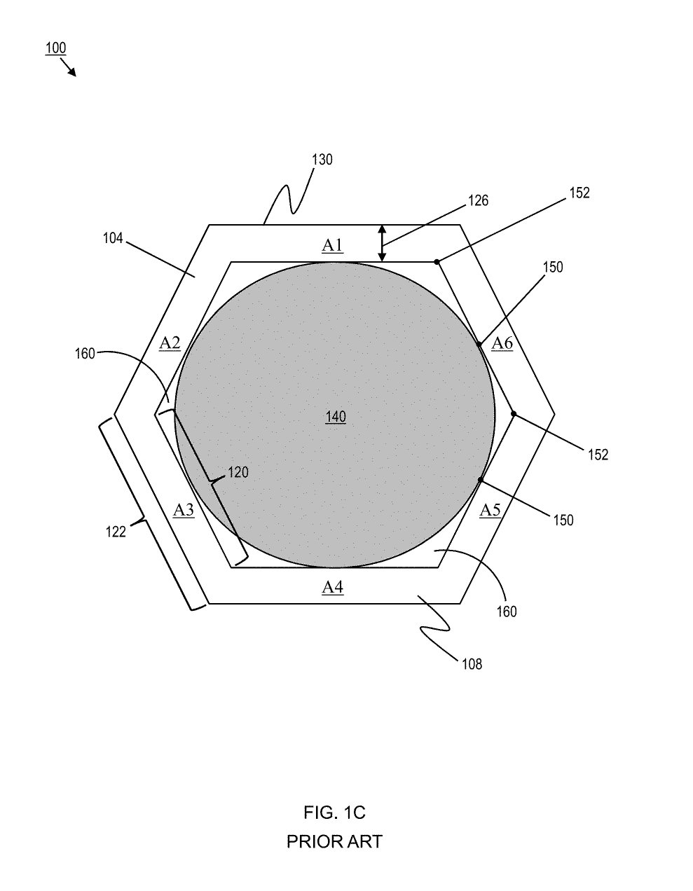

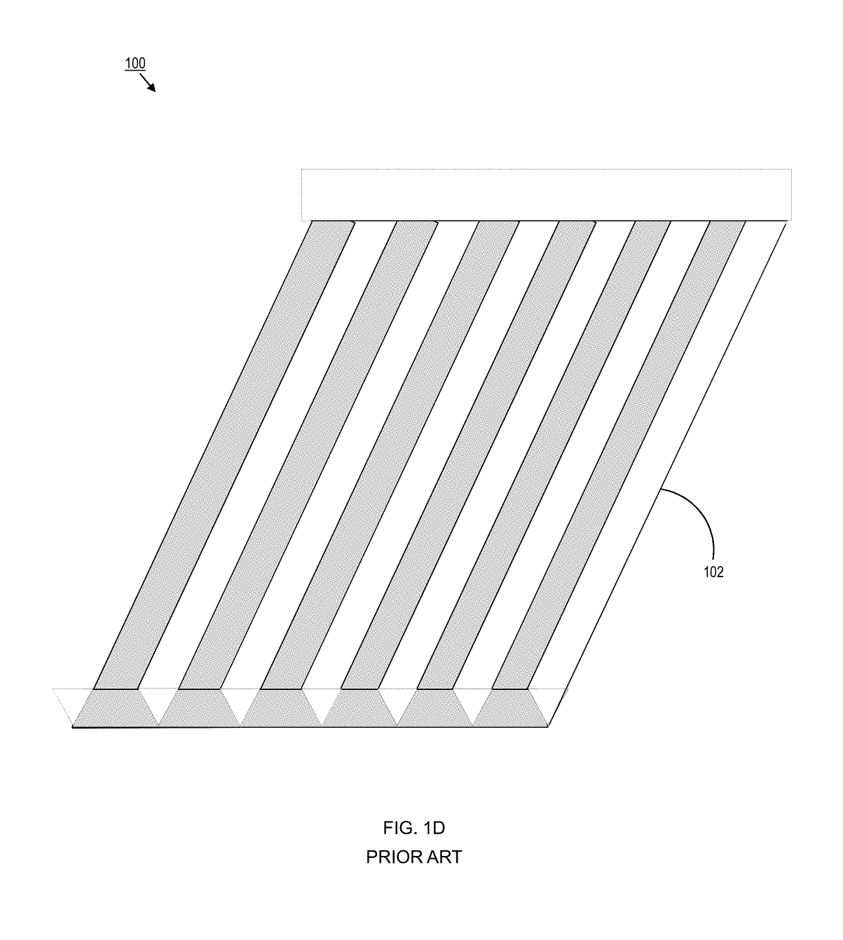

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

The general inventive concepts encompass improved pipe insulation. The pipe insulation is formed as a flat, grooved board that more readily conforms to an outer surface of a pipe during installation of the pipe insulation on the pipe.

In general, the improved pipe insulation may eliminate or otherwise reduce the need to manually remove a portion of the insulating material to accommodate projections that extend beyond an outer circumference of a pipe to be insulated.

In general, the improved pipe insulation may increase the ease with which the pipe insulation can be installed on a pipe to be insulated.

In general, the improved pipe insulation may increase the speed at which the pipe insulation can be installed on a pipe to be insulated.

In general, the improved pipe insulation may eliminate or otherwise reduce the presence of gaps between the insulating material and a pipe to be insulated.

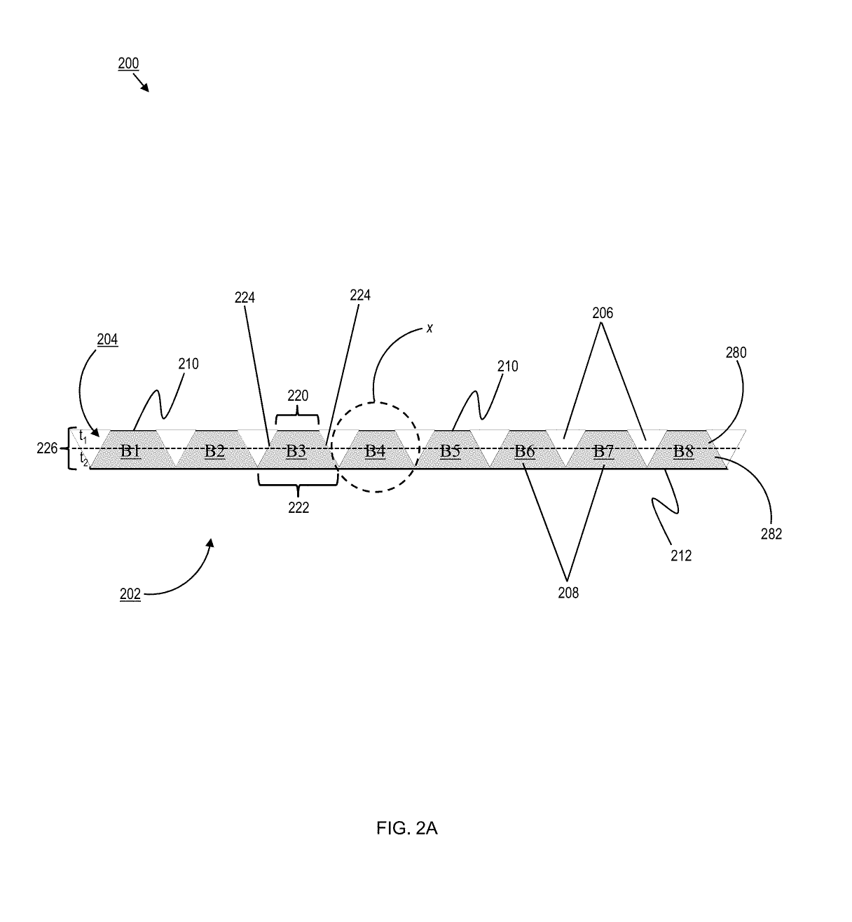

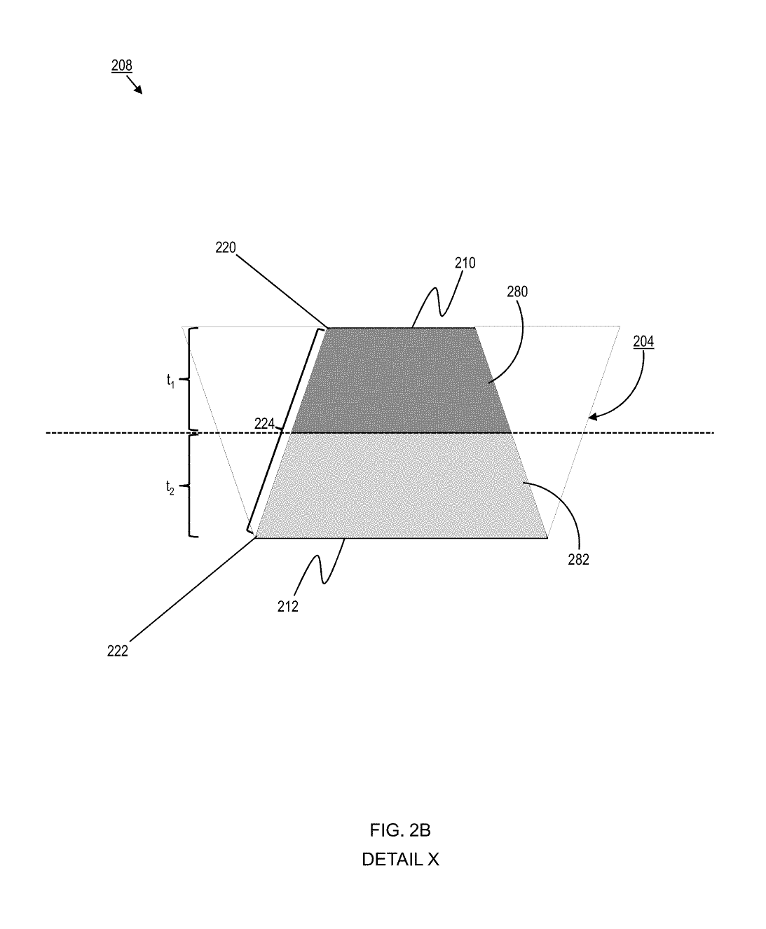

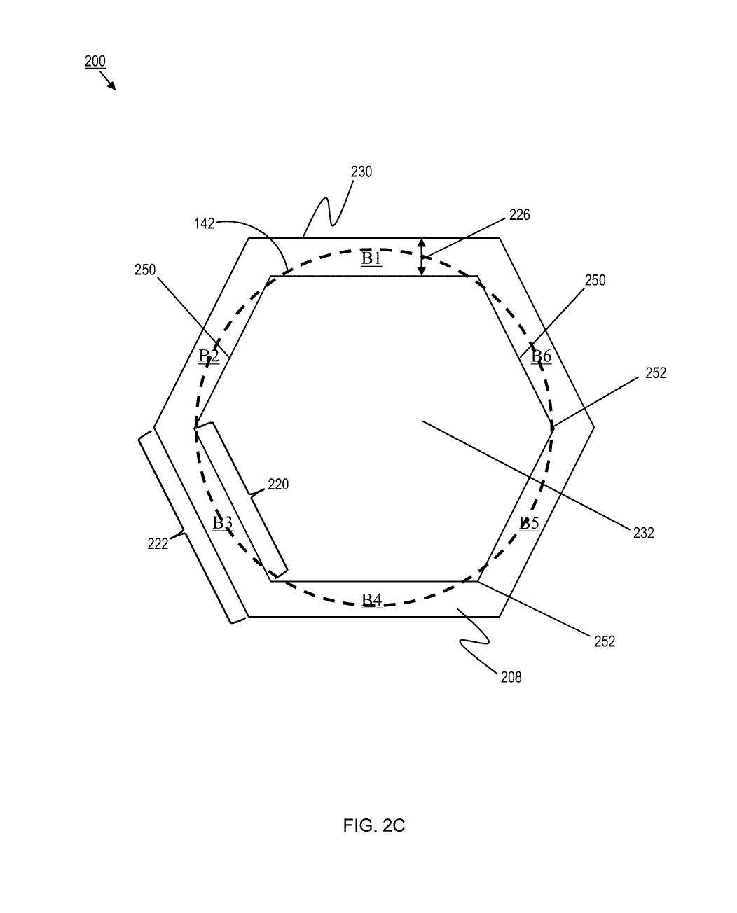

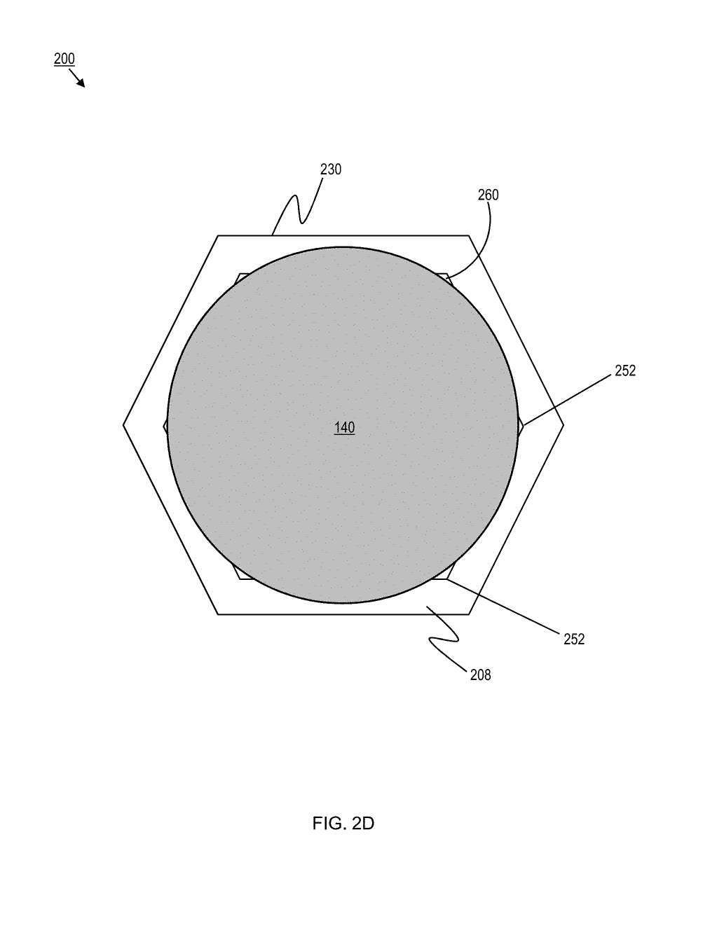

An exemplary embodiment of the improved pipe insulation 200 will be described with reference to FIGS. 2A-2D. As shown in FIG. 2A, the pipe insulation 200 is formed as a flat board 202 of an insulating material 204. The insulating material 204 is typically a fibrous insulating material, such as a fiberglass insulating material or a mineral wool insulating material. Lengthwise v-grooves 206 are cut into the board 202 to form separate segments 208 of the insulating material 204. In FIG. 2A, eight of the segments 208 are shown, i.e., B1, B2, B3, B4, B5, B6, B7, and B8.

Optionally, a facing material 210 and/or a backing material 212 may be affixed to the insulating material 204, typically before the v-grooves 206 are cut into the insulating material 204. During installation, the facing material 210 will be situated between the insulating material 204 and a pipe 140 to be insulated. During installation, the backing material 212 will be situated outside of the insulating material 204 furthest from the pipe 140. These materials 210, 212 can serve any of a number of purposes, such as acting as a vapor barrier or adding support to the segments 208 of the insulating material 204.

Each segment 208 has a trapezoidal shape. Typically, each segment 208 will have the shape of an isosceles trapezoid, with an upper base 220 and a lower base 222. The upper base 220 and the lower base 222 are connected by a pair of legs 224. The upper base 220 and the lower base 222 are parallel to one another, while the legs 224 are not parallel to one another. A thickness 226 of the insulating material 204 is defined by the distance between the upper base 220 and the lower base 222.

In conventional pipe insulation formed as a flat, grooved board (e.g., the pipe insulation 100), the insulating material 104 is substantially rigid through its thickness 126. Conversely, in the pipe insulation 200 formed as a flat, grooved board, the insulating material 204 is not substantially rigid through its thickness 226. Instead, the insulating material 204 has a non-homogenous composition through its thickness 226. This non-homogenous composition will be further described with reference to the single segment 208 shown in FIG. 2B.

In particular, the representative segment 208 of the insulating material 204 includes an inner region 280 of a first insulating material and an outer region 282 of a second insulating material. The inner region 280 extends from the upper base 220 to the outer region 282. The outer region 282 extends from the lower base 222 to the inner region 280.

The thickness 226 of the pipe insulation 200 is equal to the sum of a thickness t₁ of the inner region 280 and a thickness t₂ of the outer region 282. In some exemplary embodiments, the thickness t₁ of the inner region 280 is less than the thickness t₂ of the outer region 282. In some exemplary embodiments, the thickness t₁ of the inner region 280 is equal to the thickness t₂ of the outer region 282. In some exemplary embodiments, the thickness t₁ of the inner region 280 is greater than the thickness t₂ of the outer region 282.

In some exemplary embodiments, the thickness t₁ of the inner region 280 is at least 10% of the total thickness 226 of the pipe insulation 200. In some exemplary embodiments, the thickness t₁ of the inner region 280 is at least 20% of the total thickness 226 of the pipe insulation 200. In some exemplary embodiments, the thickness t₁ of the inner region 280 is at least 30% of the total thickness 226 of the pipe insulation 200. In some exemplary embodiments, the thickness t₁ of the inner region 280 is at least 40% of the total thickness 226 of the pipe insulation 200. In some exemplary embodiments, the thickness t₁ of the inner region 280 is at least 50% of the total thickness 226 of the pipe insulation 200.

While the outer region 282 of insulating material may be rigid (e.g., similar to the insulating material 104 of the conventional pipe insulation 100), the inner region 280 of insulating material is not. In particular, the insulating material of the inner region 280 is less rigid than the insulating material of the outer region 282. In other words, the insulating material of the inner region 280 is more compressible than the insulating material of the outer region 282. Various attributes can be controlled to reduce the rigidness of the insulating material of the inner region 280 including, for example, the density of the insulating material, the diameter of the fibers comprising the insulating material, the amount of binder (LOI) on the insulating material, and the type of binder on the insulating material. Consequently, upon installation, the pipe insulation 200 more readily fits around a pipe and any fittings, projections, or other structures (e.g., flanges, valves) extending from or in proximity to an outer surface of the pipe 140.

As with the conventional pipe insulation 100, the v-grooves 206 described above allow the board 202 to be manipulated such that the legs 224 of adjacent segments 208 abut one another, thereby closing the v-groove 206 situated between the adjacent segments 208. In this manner, the flat board 202 is transformed into an elongated, hollow polygon of the insulating material 204, the polygon having n sides with n being the number of the segments 208 forming the polygon.

During installation, the board 202 is typically wrapped around the pipe 140 to be insulated until the insulating material 204 completely surrounds the pipe 140. Thereafter, the portion of the board 202 surrounding the pipe 140 can be separated from the rest of the board 202 and sealed to hold its shape. Of course, the width of the board 202 can be selected or otherwise pre-calculated to match a size of the pipe 140 being insulated. In this manner, a polygon insulating member is formed which has the minimum number of sides required to surround the pipe 140.

For example, as shown in FIG. 2C, the pipe insulation 200 is represented by the board 202 being transformed into a hexagonal insulating member 230. The insulating member 230 is an elongated, hollow polygon formed from six of the segments 208 of the insulating material 204 (i.e., B1, B2, B3, B4, B5, and B6). The insulating member 230 includes an inner cavity 232 for receiving the pipe 140 to be insulated by the insulating member 230.

Because the inner region 280 of the insulating material 204 is not substantially rigid, the cavity 232 of insulating member 230 can more closely approximate an outer circumference 142 of the pipe 140. This can be seen in FIG. 2C, where the outer circumference 142 of the pipe 140 (shown as a dashed line) is able to extend into the inner region 280 of the insulating material 204. In other words, the outer circumference 142 of the pipe 140 can extend past the mid-points 250 of the segments 208 of the insulating material 204. Likewise, the outer circumference 142 of the pipe 140 can more closely approach (or even extend past) the corners 252 formed where adjacent segments 208 of the insulating material 204 abut one another. In some exemplary embodiments, the outer circumference 142 of the pipe 140 defines a circle extending through a majority of the inner corners 252 of the insulating member 230. As a result, as shown in FIG. 2D, any gaps 260 between the outer surface of the pipe 140 and the inner surface of the insulating member 230 are significantly reduced, if not eliminated, as compared with the gaps (e.g., gaps 160) seen with conventional pipe insulation.

Furthermore, because the inner region 280 of the insulating material 204 is compressible, the cavity 232 of insulating member 230 can more readily conform to fittings, projections, or other structures (e.g., flanges, valves) that extend beyond an outer circumference 142 of the pipe 140. This avoids the problem with conventional pipe insulation of having to use a larger insulating member than necessary to surround the pipe in order to accommodate the fittings, which is wasteful and gives rise to undesirable gaps between the insulating member and the pipe insulation. In other words, given its enhanced conformability, the pipe insulation 200 may be able to surround the pipe 140 with an insulating member comprising fewer segments (e.g., a lower n value) than possible with conventional pipe insulation (e.g., the pipe insulation 100). Furthermore, given its enhanced conformability, the pipe insulation 200 may be able to surround the pipe 140 and its fittings without requiring removal of any of the insulating material 204.

The general inventive concepts also encompass methods of and systems for making the inventive pipe insulation disclosed or otherwise suggested herein. For example, it is known to use multiple spinnerettes to form fibrous insulation boards. As noted above, various attributes can be controlled to reduce the rigidness of the insulating material in a portion of the inventive insulation boards described herein. These attributes include, but are not limited to, the density of the insulating material, the diameter of the fibers comprising the insulating material, the amount of binder (LOI) on the insulating material, and the type of binder on the insulating material. Accordingly, different spinnerettes could be used to vary these attributes as the board moves down a production line.

The scope of the general inventive concepts are not intended to be limited to the particular exemplary embodiments shown and described herein. From the disclosure given, those skilled in the art will not only understand the general inventive concepts and their attendant advantages, but will also find apparent various changes and modifications to the methods and systems disclosed. It is sought, therefore, to cover all such changes and modifications as fall within the spirit and scope of the general inventive concepts, as described and claimed herein, and any equivalents thereof.

1. A pipe insulation comprising:
a flat board comprising a plurality of segments of an insulating material,
wherein each pair of adjacent segments is separated by a groove formed in the board,
wherein each of the segments of the insulating material has a thickness t,
wherein each of the segments of the insulating material includes a first region and a second region, and
wherein a compressibility of the first region of the insulating material is greater than the compressibility of the second region of the insulating material.

2. The pipe insulation of claim 1, wherein the insulating material is fiberglass.

3. The pipe insulation of claim 1, wherein the insulating material is mineral wool.

4. The pipe insulation of claim 1, wherein the insulating material in the first region differs from the insulating material in the second region.

5. The pipe insulation of claim 1, wherein the first region of the insulating material has a thickness t₁,
wherein the second region of the insulating material has a thickness t₂, and
wherein t₁+t₂=t.

6. The pipe insulation of claim 5, wherein t₁<t₂.

7. The pipe insulation of claim 5, wherein t₁=t₂.

8. The pipe insulation of claim 5, wherein t₁>t₂.

9. The pipe insulation of claim 5, wherein t₁ is at least 10% of t.

10. The pipe insulation of claim 5, wherein t₁ is at least 20% of t.

11. The pipe insulation of claim 5, wherein t₁ is at least 30% of t.

12. The pipe insulation of claim 5, wherein t₁ is at least 40% of t.

13. The pipe insulation of claim 5, wherein t₁ is at least 50% of t.

14. The pipe insulation of claim 1, wherein the board includes a facing material, such that each of the segments has the facing material on the first region of the insulating material.

15. The pipe insulation of claim 1, wherein the board includes a backing material, such that each of the segments has the backing material on the second region of the insulating material.

16. The pipe insulation of claim 1, wherein each groove has a V shape.

17. The pipe insulation of claim 1, wherein each segment has a trapezoidal shape.
